(19) United States
(12) Patent Application Publication
(10) Pub. No.: US 2020/0071992 A1
(43) Pub. Date: Mar. 5, 2020

(54) Non-Uniform Disordered Optical Gratings Formed Through Spontaneous Buckling For Improved Lighting Conditions

(71) Applicant: Battelle Memorial Institute, Richland, WA (US)

(72) Inventors: Bruce E. Bernacki, Kennewick, WA (US); Kyle J. Alvine, Richland, WA (US); Brent M. DeVetter, Green Bay, WI (US)

(21) Appl. No.: 16/556,602

(22) Filed: Aug. 30, 2019

Related U.S. Application Data
(60) Provisional application No. 62/725,751, filed on Aug. 31, 2018.

(51) Int. Cl. E06B 9/24; B05D 7/00; G02B 5/18; G02B 1/04

(52) U.S. Cl. CPC E06B 9/24; B05D 7/532; G02B 5/1852; E06B 2009/2417; G02B 1/04; G02B 5/1866; G02B 5/1828

(57) ABSTRACT

The present disclosure describes example methods and structures directed to a non-uniform disordered optical grating formed though spontaneous buckling. The non-uniform disordered optical grating, which can be used as part of a light-dispersing structure to improve lighting conditions, may be formed from a bilayer coating of polymeric materials that is deposited and cured on a sacrificial substrate. The light-dispersing structure effectuates the spreading of incident light without noticeable chromatic dispersion due to its stochastic patterning, thus enhancing daylight penetration and improving lighting conditions.

### PRIORITY/CROSS-REFERENCE TO RELATED APPLICATIONS

This application claims the benefit of U.S. provisional application No. 62/725,751, filed on Aug. 31, 2018, the disclosure of which is hereby incorporated by reference.

### STATEMENT AS TO RIGHTS TO DISCLOSURES MADE UNDER FEDERALLY-SPONSORED RESEARCH AND DEVELOPMENT

This disclosure was made with Government support under Contract DE-AC0576RL01830 awarded by the U.S. Department of Energy. The Government has certain rights in the invention.

### BACKGROUND

Technologies for directing daylight deeper within a building space are highly sought after for energy efficiency applications in order to offset artificial lighting costs and to improve workplace productivity via the use of natural light. Vertical window coatings that can perform this task by redistributing sunlight deeper into a space are especially attractive as they are significantly more straightforward to incorporate into a wide variety of architectures and can retrofit into existing facades as compared to roof-based skylights or bulky horizontal daylight shelf-type options. The potential energy savings are even greater when one takes into account the fact that such technologies would mitigate harsh glare, allowing window shades to be open for longer portions of the day. However, low-cost and readily scalable techniques are essential for widespread adoption of these window coating technologies.

### SUMMARY

The present disclosure describes example methods and structures directed to non-uniform disordered optical grating formed through spontaneous buckling. The non-uniform disordered optical grating, which can be used as part of a light-dispersing structure to improve lighting conditions, may be formed from a bilayer coating of polymeric materials that are deposited and cured on a sacrificial substrate. The light-dispersing structure effectuates the spreading of incident light without noticeable chromatic dispersion due to its stochastic patterning, thus enhancing daylight penetration and improving lighting conditions.

A light-dispersing structure using the non-uniform disordered optical grating (e.g., a windowpane covered with the non-uniform disordered optical grating) can provide improved methods of daylighting (bringing sunlight deeper into living spaces). The non-uniform disordered optical grating can be applied to large areas while not seriously causing undesirable color artifacts, obstructing the view of the window, and not requiring power (such as electrochromic windows). The non-uniform disordered optical grating is amenable to retrofits and can be applied on-site to existing windowpanes.

Furthermore, the non-uniform disordered optical grating has the potential to improve energy efficiency while maintaining acceptable optical clarity. Use of the non-uniform disordered optical grating will not substantially degrade views, will not create color effects, and can be optimized to spread light.

In one example, a method of forming a non-uniform disordered optical grating is described. In the method, a second layer of a second polymer material is deposited over a first layer of a first polymer material to form a bilayer coating. The second layer of the second polymer material has a mechanical stiffness that is less than that of the first layer of the first polymer material. The bilayer coating is buckled to form the non-uniform disordered optical grating.

In another example, a method of forming a non-uniform disordered optical grating is described. In the method, a bilayer coating is formed on a sacrificial substrate. The bilayer coating is formed by depositing, over an exposed surface of the sacrificial substrate, a first layer of a first polymer material; and depositing, over the first layer of the first polymer material, a second layer of a second polymer material. A compressive lateral stress is induced in a same plane as the bilayer coating using a curing operation that heats the bilayer coating at a first temperature and cools the bilayer coating at a second temperature that is less than the first temperature. The method further includes removing the bilayer coating from the sacrificial substrate, wherein removing the bilayer coating from the sacrificial substrate results in the bilayer coating spontaneously buckling from the induced lateral stresses to form the non-uniform disordered optical grating.

In another example, a light-dispersing structure is described. The light-dispersing structure comprises a translucent material and a non-uniform disordered optical grating, where the non-uniform disordered optical grating is formed from a bilayer coating that is buckled.

### BRIEF DESCRIPTION OF THE DRAWINGS

FIG. 1 illustrates an example operating environment in which disordered spontaneously-buckled non-uniform disordered optical gratings for improved lighting applications can be implemented.

FIG. 2 illustrates example details in accordance with one or more aspects of disordered spontaneously-buckled non-uniform disordered optical gratings for improved lighting applications.

FIG. 3 illustrates a flow-chart of an example method for fabricating a non-uniform disordered optical grating in accordance with one or more aspects.

FIG. 4 illustrates a flow-chart of an example method for fabricating a non-uniform disordered optical grating in accordance with one or more aspects.

FIG. 5 illustrates example data corresponding to optical performance and tunability of non-uniform disordered optical gratings formed through spontaneous buckling in accordance with one or more aspects.

FIG. 6 illustrates example data corresponding to widths of transmission bands for non-uniform disordered optical gratings formed through spontaneous buckling in accordance with one or more aspects.

FIG. 7 illustrates example data corresponding to the stochastic nature of non-uniform disordered optical gratings formed through spontaneous buckling in accordance with one or more aspects.

### NOMENCLATURE

° C. degrees Celsius
CFL compact fluorescent lamp
d period
CVD chemical vapor deposition
E Young's modulus
h thickness
nm nanometer
LED light emitting diode
PDMS polydimethylsiloxane
PET Polyethylene terephthalate material
PS polystyrene
PU polyurethane
PVD physical vapor deposition

### Si Silicon

SiO₂ silicon dioxide
μm micrometer
v Poisson's ratio

### DETAILED DESCRIPTION

The following description includes an example mode of a preferred embodiment of the present disclosure. It will be clear from this description of the disclosure that the disclosure is not limited to the illustrated embodiment but that improvements include a variety of modifications and embodiments thereto. Therefore the present description should be seen as an illustrative example and not limiting.

The use of “e.g.,” “etc.,” “for instance,” “in example,” “for example,” and “or”, as well as other grammatically related terms, indicates non-exclusive alternatives without limitation, unless the context clearly dictates otherwise. The use of “including” and other grammatically related terms means “including, but not limited to,” unless the context clearly dictates otherwise. The use of the articles “a,” “an” and “the” are meant to be interpreted as referring to the singular as well as the plural, unless the context clearly dictates otherwise. Words of approximation (e.g., “generally”), as used in context of the specification and figures, are intended to take on their ordinary and customary meanings which denote approximation, unless the context clearly dictates otherwise.

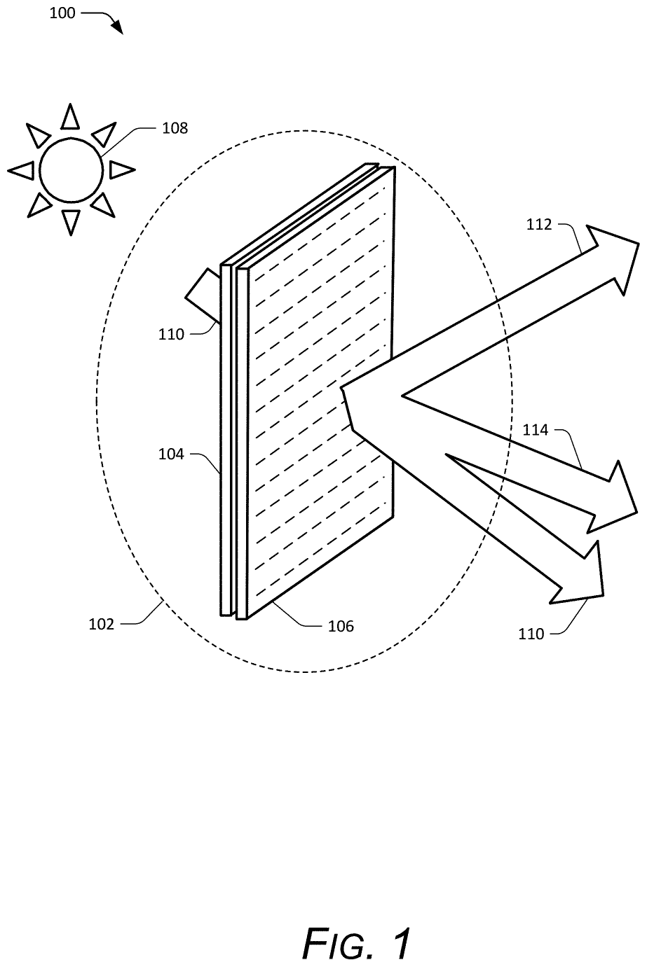

FIG. 1 illustrates an example operating environment 100 in which non-uniform disordered optical gratings for improved lighting applications can be implemented. As illustrated, a light-dispersing structure 102 includes a translucent material 104 and a non-uniform disordered optical grating 106. The translucent material 104 may be, for example, a glass material, a plastic material, or a plexiglass material. The translucent material 104 may be formed as a windowpane. Generally, the non-uniform disordered optical grating 106 may be formed from a bilayer coating that is buckled spontaneously and improves lighting conditions.

In the operating environment 100, and as illustrated, the light-dispersing structure 102 is directed to a daylighting application. A light source 108 (e.g., the sun) is radiating light waves through the light-dispersing structure 102. The presence of the non-uniform disordered optical grating 106 causes the light waves to be dispersed and redirected from a natural incidence path 110 to one or more other dispersion paths 112, 114 (e.g., paths corresponding to one or more other angles of diffraction). Such a dispersion and redirection of light waves may, in some instances, increase the overall lighting of a room and/or reduce glare.

Although FIG. 1 illustrates the light-dispersing structure 102 including a windowpane (e.g., a planar environmental barrier that is translucent), the light-dispersing structure 102 may include other elements or take other forms. For example, the light-dispersing structure 102 may include a light source (e.g., a light-emitting diode (LED) panel, an incandescent lamp, a high-intensity discharge lamp, a halogen incandescent lamp, a compact fluorescent lamp (CFL)). The light-dispersing structure may also, in some instances, be non-planar, for example having a curvature.

In some instances, the non-uniform disordered optical grating 106 may be fixed to the light-dispersing structure 102. Examples include adhering surfaces of the non-uniform disordered optical grating 106 and/or tacking portions of the non-uniform disordered optical grating 106 to the light-dispersing structure. The non-uniform disordered optical grating 106 may also be fixed to the light-dispersing structure 102 using heat compression techniques. In some other instances, the non-uniform disordered optical grating 106 may be separated from the light-dispersing structure 102 using mechanical standoffs.

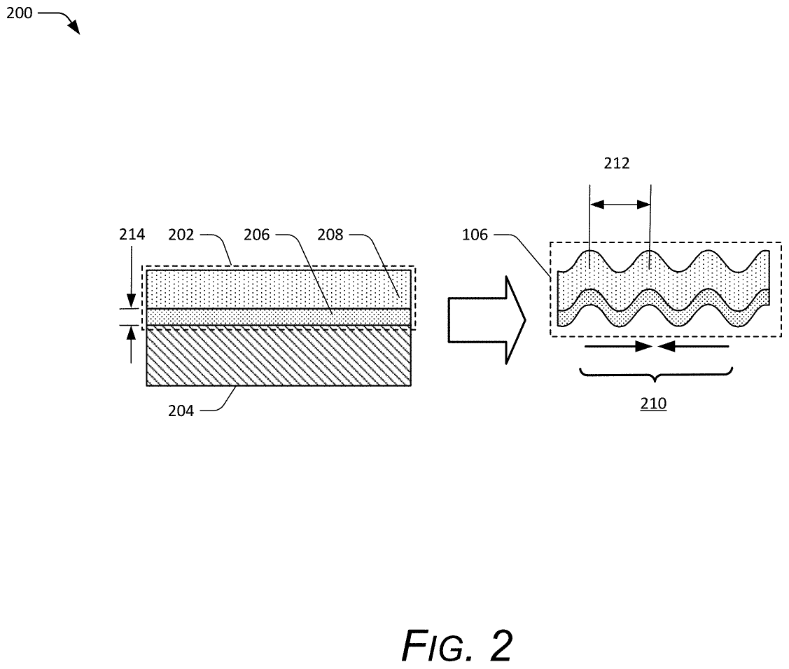

FIG. 2 illustrates example details 200 in accordance with one or more aspects of disordered spontaneously buckled non-uniform disordered optical gratings for improved lighting applications. The example details 200 illustrate an overview of a fabrication process for a non-uniform disordered optical grating.

As illustrated, a bilayer coating 202 is deposited onto a sacrificial substrate 204. Example materials used by the sacrificial substrate 204 include a silicon (Si) material and a silicon dioxide (SiO₂) material. The sacrificial substrate 204 may also be other materials than the cited examples. In some instances, the sacrificial substrate 204 may be circular and planar in nature (e.g., a “wafer”). In other instances, the sacrificial substrate 204 may be rectangular and planar in nature. In other instances, the sacrificial substrate 204 may be square and planar in nature.

The bilayer coating 202 includes a first layer 206 of a first polymer material and a second layer 208 of a second polymer material. The first polymer material may be, for example, a polystyrene (PS) material or a polyurethane (PU) material. The second polymer material may be, for example, a polydimethylsiloxane (PDMS) material or a polyethylene terephthalate (PET) material. The bilayer coating 202 may also use polymer materials other than the examples cited above.

A variety of wet-deposition techniques may be used to deposit the first layer 206 of the first polymer material and the second layer 208 of the second polymer material onto the sacrificial substrate 204, including, but not limited to, spin casting and pouring. Furthermore, and generally, the first layer 206 of the first polymer material and the second layer 208 of the second polymer material may each be of a thickness that is less than five hundred nanometers (nm). Preferably, the second layer 208 of the second polymer material will have a thickness greater than the first layer 206 of the first polymer material.

Generally, the first layer 206 of the first polymer material may have a mechanical stiffness (e.g., resistance to deflection and/or deformation) that is greater than that of the second layer 208 of the second polymer material. The mechanical stiffness may be a result of respective, physical properties of the first layer 206 of the first polymer material and the second layer 208 of the second polymer material, such as an elastic modulus (e.g., Young's modulus, E) and the thickness.

The bilayer coating 202 (while on the sacrificial substrate 204) may be subject to a curing process using preselected conditions. As an example, the curing process may include heating (using a chamber) the bilayer coating 202 at a temperature between 55° C. and 65° C. (e.g., 60° C.) for a time duration (e.g., twelve hours), and then cooling the bilayer coating 202 at a temperature between 20° C. and 25° C. (e.g., 23° C.) for another time duration (e.g., twelve hours). The curing process, due to the differences in coefficients of thermal expansion between the sacrificial substrate 204 and the second layer 208 of the second material, induces a compressive lateral stress 210 in a same plane of the bilayer coating 202 as the bilayer coating 202 cools.

Manufacturing processes, including peeling and/or using a release agent, may be used to remove the bilayer coating 202 from the sacrificial substrate 204. Upon removal from the sacrificial substrate, the bilayer coating 202 will seek to minimize strain energy resulting from the induced, compressive lateral stress 210 in the same plane of the bilayer coating 202 through spontaneous buckling to form the non-uniform disordered optical grating 106.

For a bilayer system (e.g., the non-uniform disordered optical grating 106) having a thin layer of a “stiff” material (e.g., the first layer 206 of the first polymer material) in contact with a thick layer of a “soft” material (e.g., the second layer 208 of the second polymer material), the period 212 (e.g., wavelength of the buckling) can be described through the mathematical relationship (1):

$$d = 2 π {h [ \frac{( 1 - {v}_{s}^{2} ) {E}_{f}}{3 ( 1 - {v}_{f}^{2} ) {E}_{s}} ]}^{1 / 3} \qquad ( 1 )$$

In mathematical relationship (1), d is the period, vₛ and v_{f} are Poisson's ratio for the sacrificial substrate 204 and the soft material (e.g., the second layer 208 of the second polymer material), h is the thickness of the thin layer of the stiff material (e.g., the first layer 206 of the first polymer material), and E_{f} and Eₛ are, respectively, Young's modulus for the sacrificial substrate 204 and the soft material (e.g., the second layer 208 of the second polymer material).

The period 212 of the non-uniform disordered optical grating 106 may be tuned, in some instances, by adjusting a thickness (e.g., the thickness 214) the first layer 206 of the first polymer material. Table 1, below, represents example data indicative of such tuning performed in a laboratory environment. In the laboratory, thickness dimensions were measured using contact profilometry and the periods were determined by analyzing optical microscopy images.

TABLE 1

| Spin-Cast Parameters | PS Thickness | Period |
|---|---|---|
| 8000 rpm; 6000 rpm/s | 220 nm | 13 μm |
| 8000 rpm; 2000 rpm/s | 300 nm | 16 μm |
| 4000 rpm; 1000 rpm/s | 350 nm | 18 μm |

In the laboratory environment, sample bilayer coatings (e.g., bilayer coating 202) of respective first layers of polystyrene (PS) material (e.g., first layer 206 of the first polymer material) and respective second layers of a polydimethylsiloxane (PDMS) material (e.g., second layer 208 of the second polymer material) were deposited on a sacrificial substrate (e.g., sacrificial substrate 204), cured, and removed from the sacrificial substrate. For the samples, and as represented by Table 1, the respective first layers of the PS material were deposited using different spin-cast parameters resulting in different thicknesses. Also, as represented by Table 1, increases in the PS thickness (e.g., thickness 214) correspond to increases in periods (e.g., period 212) of the non-uniform disordered optical grating 106.

In general, other manufacturing processes than those described may be used as part of fabricating the non-uniform disordered optical grating 106. Such other manufacturing processes may be material dependent and can include chemical vapor deposition (CVD), physical vapor deposition (PVD), sputtering, roll-to-roll application, etching, lithography, and so on.

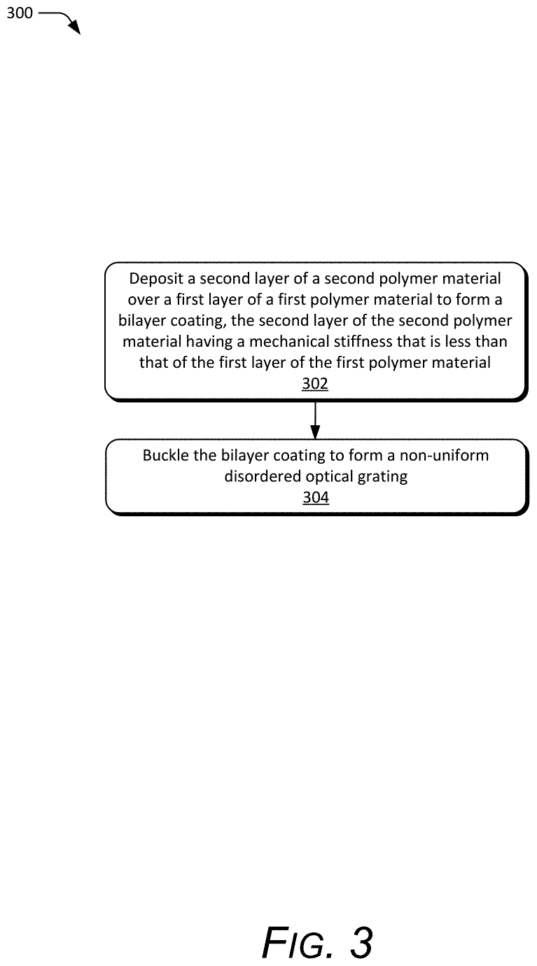

FIG. 3 illustrates a flow-chart of an example method 300 for fabricating a non-uniform disordered optical grating (e.g., the non-uniform disordered optical grating 106) in accordance with one or more aspects. Although described in a series of operational blocks 302 and 304, sequencing of the operational blocks (and detailed descriptions within the operational blocks) is not necessarily limited as described. In general, the method 300 may be performed using a combination of tools that include deposition tools for depositing materials and chamber tools for curing materials. Furthermore, the method 300 may use elements of FIG. 1 and FIG. 2. In some instances, the non-uniform disordered optical grating 106 may be used for a daylighting application.

At block 302, operations include depositing a second layer 208 of a second polymer material over a first layer 206 of a first polymer material to form a bilayer coating 202. The second layer 208 of the second polymer material has a mechanical stiffness that is less than that of the first layer 206 of the first polymer material. The first polymer material may be, for example, a polystyrene (PS) material or a polyurethane (PU) material. The second polymer material may be, for example, a polydimethylsiloxane (PDMS) material or a polyethylene terephthalate material.

In some instances, block 302 may further include operations that deposit the first layer 206 of the first polymer material onto a sacrificial substrate 204. The sacrificial substrate 204 may be, for example, formed from a silicon (Si) material and/or a silicon-dioxide (SiO₂) material.

At block 304, the operations include buckling the bilayer coating 202 to form the non-uniform disordered optical grating 106. In some instances, the buckling of the bilayer coating 202 may be a result of a compressive lateral stress 210 in a same plane of the bilayer coating 202 that is induced by a curing operation that cures the bilayer coating 202 under preselected conditions. Furthermore, and in some instances, a period 212 of the non-uniform disordered optical grating 106 may be tunable based on varying a thickness 214 of the first layer 206 of the first polymer material.

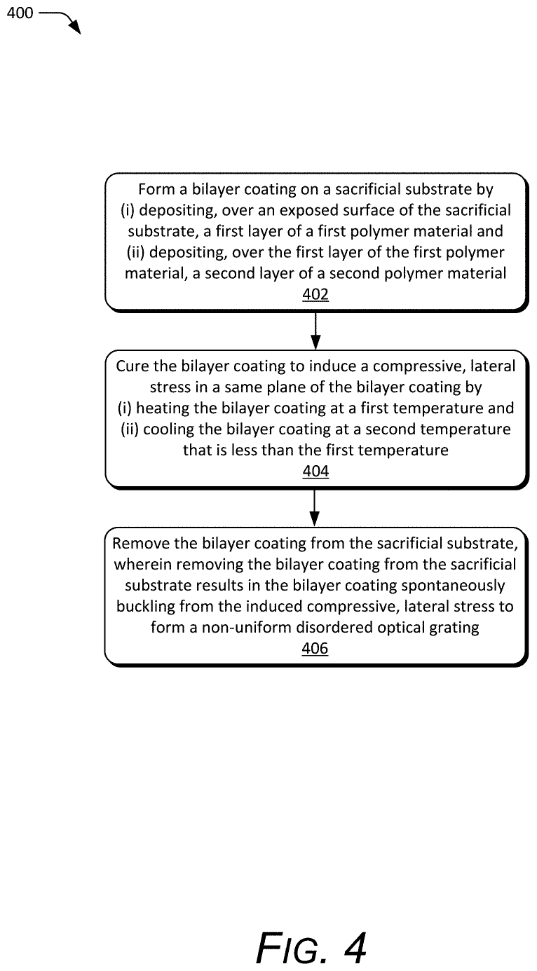

FIG. 4 illustrates a flow-chart of an example method 400 for fabricating a non-uniform disordered optical grating in accordance with one or more aspects. Although described in a series of operational blocks 402-406, sequencing of the operational blocks (and sequencing of detailed descriptions within the operational blocks) is not necessarily limited as described. In general, the method may be performed using a combination of tools that include deposition tools for depositing materials and chamber tools for curing materials. Furthermore, the method 400 may use elements of FIG. 1 and FIG. 2. In some instances, the non-uniform disordered optical grating 106 may be used for a daylighting application.

At block 402, the method 400 includes forming a bilayer coating 202 on a sacrificial substrate 204. The bilayer coating 202 is formed by depositing, over an exposed surface of the sacrificial substrate, a first layer 206 of a first polymer material, and depositing, over the first layer 206 of the first polymer material, a second layer 208 of a second polymer material.

In some instances, depositing the first layer 206 of the first polymer material may include depositing a layer of a polystyrene (PS) material that is less than five hundred nanometers (nm) in thickness. In some instances, depositing the second layer 208 of the second polymer material may include depositing a layer of a polydimethylsiloxane (PDMS) material that is less than five hundred nanometers (nm) in thickness. Furthermore, the first layer 206 of the first polymer material may be of a thickness 214 that is less than that of the second layer 208 of the second polymer material.

At block 404, the method 400 includes a curing operation that cures the bilayer coating 220. The curing operation introduces a compressive lateral stress 210 in a same plane of the bilayer coating 202. The operation includes heating the bilayer coating 202 at a first temperature and cooling the bilayer coating 202 at a second temperature that is less than the first temperature.

In some instances at block 404, heating the bilayer coating 202 at the first temperature includes heating the bilayer coating at a temperature that is between fifty-five and sixty-five degrees Celsius. In some instances at block 404, cooling the bilayer coating 202 at the second temperature includes cooling the bilayer at a temperature that is between twenty and twenty-five degrees Celsius.

At block 406, the method 400 includes removing the bilayer coating 202 from the sacrificial substrate 204. Removing the bilayer coating 202 from sacrificial substrate 204 results in the bilayer coating 202 spontaneously buckling from the induced, compressive lateral stress 210 to form the non-uniform disordered optical grating 106.

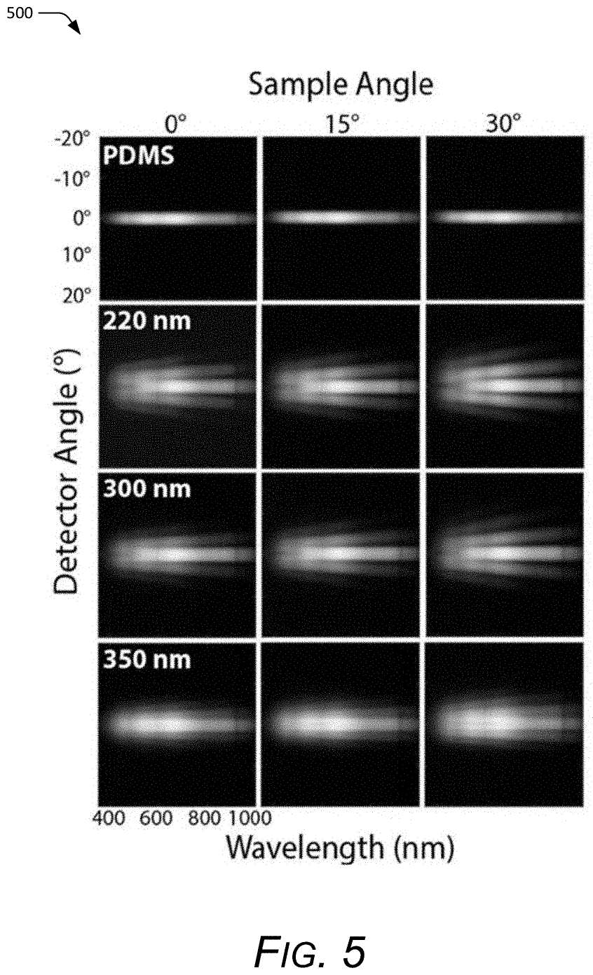

FIG. 5 illustrates example data 500 corresponding to optical performance and tunability of non-uniform disordered optical gratings formed through spontaneous buckling in accordance with one or more aspects. The data may correspond to different non-uniform disordered optical gratings (e.g., the non-uniform disordered optical grating 106) fabricated in accordance with descriptions above.

As represented in FIG. 5, sample angles with respect to incident light were varied from 0°, 15°, and 30° (where for 0° the sample is perpendicular to the incident light) and a detector was rotated from −20° to 20°. For clarity purposes, only a limited detector angle range is represented by FIG. 5 (higher-order diffraction modes were not visually observed beyond +/−20°). Using a spectrometer, the spectra of white transmission light ranging from 400 nm to 1000 nm in wavelength were recorded to illustrate the effect of both visible and near-infrared light.

Samples of the non-uniform disordered optical grating (e.g., the non-uniform disordered optical grating 106) include a reference unbuckled sample and buckled samples comprising respective layers of PS having thicknesses of 220 nm, 300 nm, and 350 nm. As illustrated, the buckled sample having the thickest layer of PS (e.g., 350 nm) has less angular spread and exhibits less chromatic dispersion than the buckled samples having thinner layers of PS (e.g., 300 nm and 220 nm). The samples of the non-uniform disordered optical grating also include a reference sample that is unbuckled (labeled “PDMS”) for reference purposes.

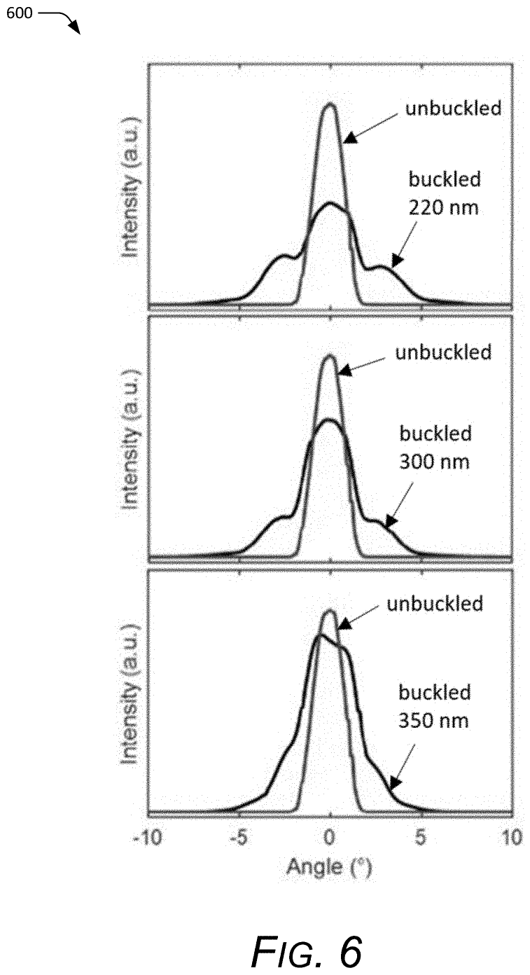

FIG. 6 illustrates example data 600 corresponding to widths of transmission bands for non-uniform disordered optical gratings formed through spontaneous buckling in accordance with one or more aspects. The data may correspond to different non-uniform disordered optical gratings (e.g., the non-uniform disordered optical grating 106) fabricated in accordance with descriptions above.

As illustrated in FIG. 6, widths of transmission bands of light for non-uniform disordered optical gratings formed through spontaneous buckling in accordance with one or more aspects. The buckled samples are greater in comparison to the transmission band of the unbuckled sample. The buckled sample having the thinnest layer of PS (e.g., 220 nm) exhibited the highest intensity of light scattering into side lobes, whereas the buckled sample having the thickest layer of PS (e.g., 350 nm) had a more gradual curve without side lobes.

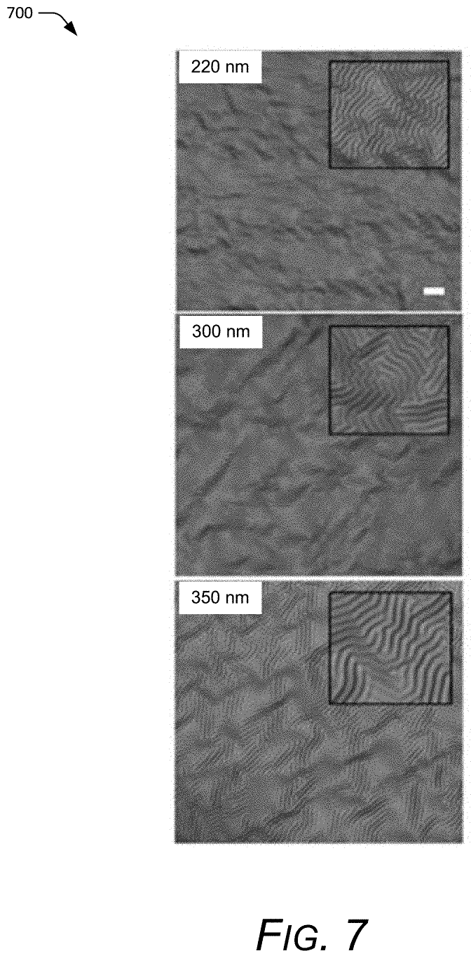

FIG. 7 illustrates example data 700 corresponding to the stochastic nature of non-uniform disordered optical gratings formed through spontaneous buckling in accordance with one or more aspects. The data may correspond to different non-uniform disordered optical gratings (e.g., the non-uniform disordered optical grating 106) fabricated in accordance with descriptions above.

As represented in FIG. 7, optical microscopy confirms the stochastic nature of the buckled samples. From the images, sinusoidal-like variation in amplitude and directionality indicates a successful forming of non-uniform disordered optical gratings (e.g., the non-uniform disordered optical grating 106) for buckled samples comprising respective layers of PS having thicknesses of 220 nm, 300 nm, and 350 nm.

In conclusion, the described methods and structures can enhance daylight penetration and improve lighting conditions within a space. Such a non-uniform disordered optical grating has potential to be used as a vertical coating with minimal to moderate amount of haze and a relatively high degree of optical light transmission. Design parameters, in particular a thickness of the first layer of the first material of a bilayer coating used to fabricate the non-uniform disordered optical grating, can be used to tune the optical properties of the non-uniform disordered optical grating to achieve desired degrees of lighting performance.

While various preferred embodiments of the disclosure are described in the foregoing description and shown in the drawings, it is to be distinctly understood that this disclosure is not limited thereto but may be variously embodied to practice within the scope of the following claims. From the foregoing description, it will be apparent that various changes may be made without departing from the spirit and scope of the disclosure as defined by the following claims.

What is claimed is:

1. A method of forming a non-uniform disordered optical grating for a daylighting application, the method comprising:
depositing a second layer of a second polymer material over a first layer of a first polymer material to form a bilayer coating, wherein the second layer of the second polymer material has a mechanical stiffness that is less than that of the first layer of the first polymer material; and
buckling the bilayer coating to form the non-uniform disordered optical grating.

2. The method of claim 1, further comprising:
depositing the first layer of the first polymer material onto a sacrificial substrate.

3. The method of claim 1, wherein the first polymer material comprises polystyrene.

4. The method of claim 3, wherein the second polymer material comprises polydimethysiloxane.

5. The method of claim 1, wherein the second polymer material comprises polydimethysiloxane.

6. The method of claim 1, wherein the first polymer material comprises polyurethane.

7. The method of claim 6, wherein the second polymer material comprises polyethylene terephthalate.

8. The method of claim 1, wherein the second polymer material comprises polyethylene terephthalate.

9. The method of claim 1, wherein the buckling of the bilayer coating is a result of a compressive lateral stress in a same plane of the bilayer coating.

10. The method of claim 1, wherein the buckling of the bilayer coating is a result of an operation that cures the bilayer coating under preselected conditions to induce the lateral stress in a same plane of the bilayer coating.

11. The method of claim 1, wherein a period of the non-uniform disordered optical grating is tunable based on varying a thickness of the first layer of the first polymer material.

12. A method of forming a non-uniform disordered optical grating for a daylighting application, the method comprising:
forming a bilayer coating on a sacrificial substrate, the bilayer coating formed from a first polymer material and a second polymer material by:
depositing, over an exposed surface of the sacrificial substrate, a first layer of the first polymer material; and
depositing, over the first layer of the first polymer material, a second layer of the second polymer material;
curing the bilayer coating, the curing inducing a compressive lateral stress in a same plane of the bilayer coating and comprising:
heating the bilayer coating at a first temperature; and
cooling the bilayer coating at a second temperature that is less than the first temperature; and
removing the bilayer coating from the sacrificial substrate, wherein removing the bilayer coating from sacrificial substrate results in the bilayer coating spontaneously buckling from the induced, compressive lateral stress to form the non-uniform disordered optical grating.

13. The method of claim 12, wherein depositing the first layer of the first polymer material comprises depositing a layer of polystyrene that is less than five hundred nanometers in thickness.

14. The method of claim 12, wherein depositing the second layer of the second polymer material comprises depositing a layer of polydimethylsiloxane that is less than five hundred nanometers in thickness.

15. The method of claim 12, wherein heating the bilayer coating at the first temperature includes heating the bilayer coating at a temperature that is between fifty-five and sixty-five degrees Celsius.

16. The method of claim 12, wherein cooling the bilayer coating at the second temperature includes cooling the bilayer coating at a temperature that is between twenty and twenty-five degrees Celsius.

17. A light-dispersing structure, the light-dispersing structure comprising:
a translucent material; and
a non-uniform disordered optical grating formed from a bilayer coating that is buckled.

18. The light-dispersing structure of claim 17, wherein the translucent material comprises:
a glass material formed as a windowpane.

19. The light-dispersing structure of claim 17, wherein the translucent material comprises:
a plastic material formed as a windowpane; or
a plexiglass material formed as a windowpane.

20. The light-dispersing structure of claim 17, wherein the bilayer coating is formed from a first layer of a first polymer material and a second layer of a second polymer material, the first layer of the first polymer material having a mechanical stiffness that is greater than that of the second layer of the second polymer material.
